(19) United States
(12) Patent Application Publication
(10) Pub. No.: US 2006/0000149 A1
(43) Pub. Date: Jan. 5, 2006

(54) MODULAR VEHICLE DOOR CONSTRUCTION

(76) Inventors: Bogdan Radu, Dearborn, MI (US); Alan G. Dry, Gross Point Woods, MI (US)

Correspondence Address: WOOD, HERRON & EVANS, LLP (LEAR), 2700 CAREW TOWER, 441 VINE STREET, CINCINNATI, OH, 45202, US

(21) Appl. No.: 10/710,276

(22) Filed: Jun. 30, 2004

(51) Int. Cl. B60J 5/04

(52) U.S. Cl. 49/502

(57) ABSTRACT

A vehicle door assembly for a motor vehicle including a door frame, a trim panel secured removably to the door frame, and a carrier plate positioned between the door frame and the door trim panel. The vehicle door assembly further includes a door component fastened to both the door frame and to the carrier plate. Preferably, the door frame structurally carries at least 50 percent of the weight of the door component. An assembly including the carrier plate, the door component, and the door trim panel may be delivered as a unit to an assembly line of the motor vehicle for mounting to the door frame.

### FIELD OF THE INVENTION

The invention relates generally to vehicle doors, and more particularly to a modular vehicle door assembly.

### BACKGROUND OF THE INVENTION

Vehicle door constructions typically feature a metal door frame with a sheet metal outer panel or skin that defines the door's exterior and an inner sheet metal panel secured to the door frame about their abutting edges to form a hollow shell. Various door components, including window regulator rails, audio speakers, latches, and the like, are fastened in openings defined in the inner sheet metal panel. Covering the inner door panel is a removable trim panel that provides an aesthetically pleasing facade viewed by occupants seated in the passenger compartment of the motor vehicle. Typically disposed between the inner sheet metal panel and trim panel is a water and/or sound barrier that closes the various openings and prevents water infiltrating the interior of the door from wetting the interior surface of the trim panel. A wire harness communicates electrical connections between mechanisms attached to the vehicle door and controls on the trim panel and a cable connects the latch to an inner release handle.

An assembly line worker fastens the door components to the inner sheet metal panel and then installs the trim panel. To provide access to the interior of the door after installation, trim panels are provided with an access opening and a removable bolster covering the access opening. The access opening must be large enough to permit assembly line workers or service technicians to access the door components while the interior trim panel remains fixed to the door frame. For example, the assembly line worker must install the fasteners for the window regulator rails and drive motor through the access opening. Large access openings tend to weaken the structure of the trim panel, require additional water seals, require additional time to assemble on the production line, and restrict styling.

Another vehicle door construction initially mounts the door components to the trim panel. After the trim panel is delivered to the assembly line and positioned relative to the door frame, the assembly line worker secures the door components with fasteners to the inner sheet metal panel of the door frame. The door components are again accessed through an access opening in the trim panel. An audio speaker is directly fastened to the door frame by fasteners installed through the trim panel. After the fasteners have been installed, a speaker grill is typically applied to the trim panel and a bolster is loaded into the access opening.

Yet another vehicle door construction mounts the door components to a carrier plate and delivers the carrier plate as a separate preassembled module to the assembly line. The carrier plate is fastened to the door frame with fasteners, and then a trim panel is installed. After assembly, the carrier plate operates as a structural member that supports the door components. For example, the window regulator rails transfer the weight of the door window pane directly to the carrier plate. Therefore, most carrier plates are formed from steel or a structural composite material with sufficient strength to support the door components. A disadvantage of this style of carrier plate is that multiple fasteners are required to complete assembly. Another disadvantage is that the trim panel and the carrier panel comprise distinct units that are delivered separately to the assembly line.

What is needed therefore is a modular automotive door construction that addresses these and other deficiencies of conventional door constructions.

### SUMMARY OF INVENTION

The invention provides a vehicle door assembly for a motor vehicle comprising of a door frame, a trim panel secured removably to the door frame, and a carrier plate positioned between the door frame and the door trim panel. The vehicle door assembly further includes a door component fastened to the door frame and to the carrier plate. This assembly differs from conventional vehicle door assemblies in that the door component is secured to both the door frame and the carrier plate.

In another embodiment of the invention, a vehicle door assembly for mounting to a door frame of a motor vehicle includes a carrier plate, a door component fastened to the carrier plate, and a door trim panel secured removably to the carrier plate. This assembly differs from conventional vehicle door assemblies in that the door trim panel is removably secured to the carrier plate for the door component.

In yet another aspect of the invention, a method of assembling a vehicle door of a vehicle includes mounting a carrier plate to a door frame of the vehicle and removing the trim panel from the carrier plate to reveal a door component secured to the carrier plate. The method further includes fastening the door component to the door frame and then re-securing the trim panel to the carrier plate after the door component is fastened to the door frame.

These and other objects and advantages of the present invention shall become more apparent from the accompanying drawings and description thereof.

### BRIEF DESCRIPTION OF DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view depicting a motor vehicle door assembly, including a carrier plate in accordance with the invention;

FIG. 2 is a perspective view of the motor vehicle door assembly of FIG. 1 with the carrier plate affixed to the door frame and the trim panel removed from the carrier plate;

FIG. 3 is a perspective view of the motor vehicle door assembly of FIG. 2 depicting the trim panel re-installed to the carrier plate;

FIG. 4 is a perspective view of a carrier plate in accordance with an alternative embodiment of the invention; and

FIG. 5 is a perspective view of a carrier plate in accordance with another alternative embodiment of the invention.

### DETAILED DESCRIPTION

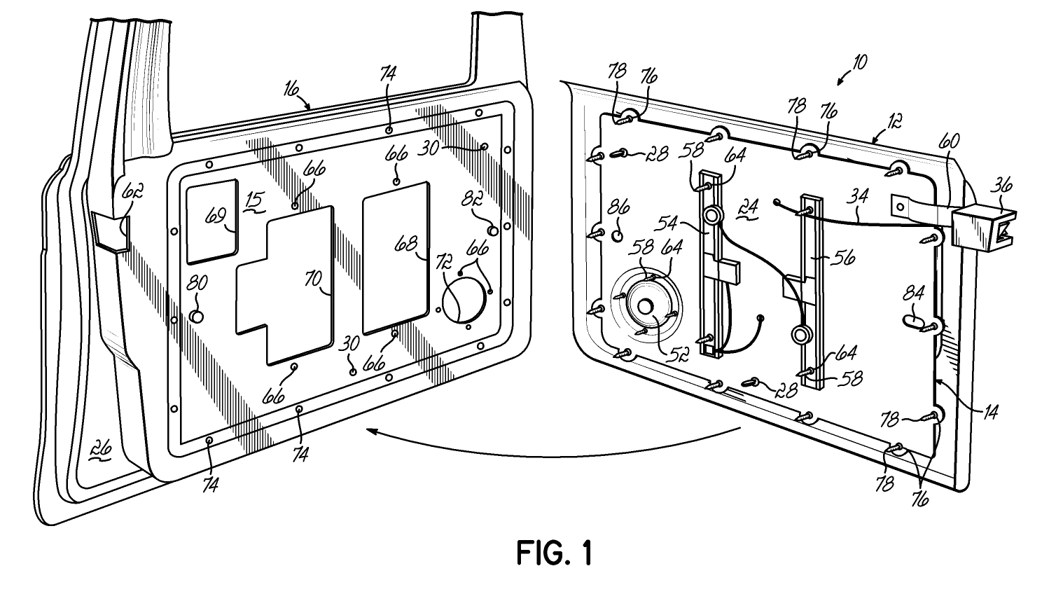

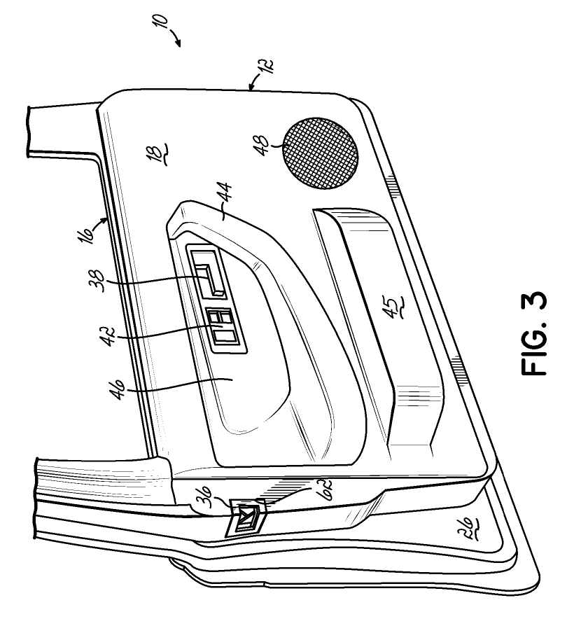

With reference to FIGS. 1-3, a vehicle door assembly 10 includes a trim panel 12 and a carrier plate 14 carrying the trim panel 12 that are collectively configured to be installed to an interiorly facing or inboard side 15 of a door frame 16 attached to a motor vehicle. When the vehicle door assembly 10 is installed to the inboard side 15 of the door frame 16, an inboard side 18 of the trim panel 12 faces into a passenger compartment of the motor vehicle and an outboard side 20 of the trim panel 12 confronts an inboard side 22 of the carrier plate 14. An outboard side 24 of the carrier plate 14 faces toward the inboard side 15 of door frame 16. An exterior panel or skin member 26 is secured to the outboard side of the door frame 16 that faces out of the passenger compartment. As used in this description, the terms such as “outboard,” “outer” and “outward” indicate a direction or orientation away from or farther from a longitudinal centerline of the motor vehicle of which the vehicle door assembly 10 forms a part. Conversely, “inboard,” “inner” and “inward” indicate a direction or orientation toward or closer to the longitudinal centerline.

The trim panel 12 is supported on and releasably secured with the carrier plate 14 by multiple connectors 28. The connectors 28 are configured for releasing trim panel 12 from the carrier plate 14, while securing the carrier plate 14 with the door frame 16, so that an assembly line worker or service technician can access various function components positioned inside of the interior space defined between the trim panel 12 and the carrier plate 14. To that end, a portion of each connector 28 affixes the carrier plate 14 to the door frame 16 and another portion of each connector 28 is removable with the trim panel 12. Suitable connectors 28 are disclosed in co-pending and commonly-owned U.S. patent application Ser. No. 10/709,544, which is hereby incorporated by reference herein in its entirety. The connectors 28 are received in suitably positioned fastener openings 30 in the door frame 16 when the trim panel 12 and carrier plate 14 are initially installed to the door frame 16. The connectors 28 fixedly attach the carrier plate 14 to the door frame 16. However, the trim panel 12 is removable by an assembly line worker after installation and, subsequently, is removable by a service technician for gaining access to the inboard side 22 of the carrier plate 14.

Penetrating through the carrier plate 14 are a terminal connector 32 of a wiring harness and a rod or cable 34 that mechanically links a door latch 36 with an inner release handle 38 positioned on the inboard side 18 of trim panel 12. The inner release handle 38 is operative for opening and closing the door latch 36. The terminal connector 32 of the wiring harness, which is coupled with a switchbox 40 located on the outboard side 20 of the trim panel 12, is electrically coupled with controls 42 on the inboard side 18 of trim panel 12. The inner release handle 38 and controls 42 are accessible to an occupant seated in the passenger compartment of the motor vehicle. The inboard side 18 of the trim panel 12 may also include other integral parts, such as an armrest 44, a pocket 45, a bolster 46, and a speaker grill 48.

A side impact absorber 50 is positioned on the outboard side 20 of the trim panel 12. The side impact absorber 50, which may be constituted by foam blocks, is supplied as a single piece. This contrasts with conventional door constructions in which, due to the presence of the access opening and removable bolster, the side impact absorbers are divided into smaller portions separated by a gap.

With continued reference to FIGS. 1-3, several door components, such as the door latch 36, an audio speaker 52, and window regulator rails 54, 56, are supported temporarily on the carrier plate 14 by fasteners 58, such as threaded fasteners, fastened to the carrier plate 14. The door latch 36 is carried by a bracket 60 depending from the carrier plate 14 at a location suitable to be received in an opening 62 in the door frame 16. The fasteners 58 are then driven into fastener openings 64 in the door latch 36, audio speaker 52, and window regulator rails 54, 56 registered with corresponding fastener openings 66 defined in the door frame 16. This fixedly mounts the door latch 36, audio speaker 52, and window regulator rails 54, 56 to the door frame 16. Accordingly, the door frame 16 provides at least a portion of the structural support for the door latch 36, audio speaker 52, and window regulator rails 54, 56 in the assembled condition. The door frame 16, rather than the carrier plate 14, preferably carries the majority of the weight of the door latch 36, audio speaker 52, and window regulator rails 54, 56 in the assembled condition. A support arm (not shown) may be coupled at opposite ends with the window regulator rails 54, 56 and a motor (not shown) may be coupled with the support arm to adjust the vertical position of the support arm on the rails 54, 56 for opening and closing a window pane (not shown) supported by the support arm.

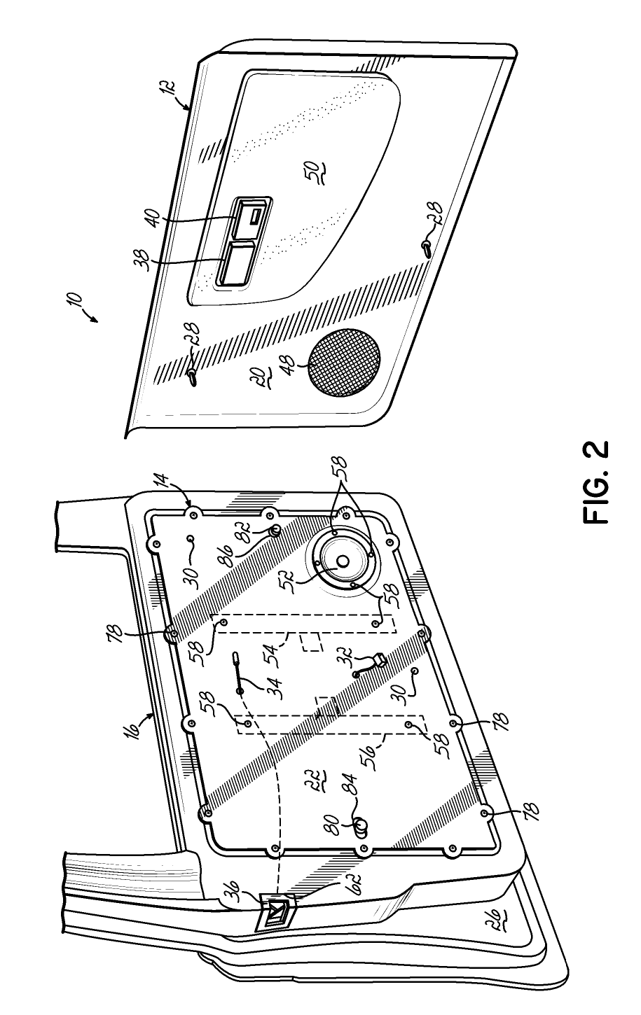

The door frame 16 includes slotted cutouts 68, 70 (FIG. 1) shaped to receive the window regulator rails 54, 56, a rectangular cutout 69 shaped for passage of the door latch 36, and a circular cutout 72 shaped to receive the backside of the audio speaker 52. Fastener openings 74 in the door frame 16 are registered during assembly with fastener openings 76 in the carrier plate 14 for receiving fasteners 78 (FIG. 2), such as threaded fasteners, that affix the carrier plate 14 to the door frame 16. Locator pins 80, 82 on the door frame 16 are positioned to engage locator openings 84, 86, respectively, in the carrier plate 14 that, when engaged, assist in assembly.

An assembly line worker or service technician may gain unhindered access to the door latch 36, audio speaker 52, and window regulator rails 54, 56 by removing the interior trim panel 12 from the carrier plate 14. The removability of the entire trim panel 12 permits the fasteners 58 to be located arbitrarily within the outer perimeter of the door frame 16. More specifically, the trim panel 12 preferably lacks a bolster, which provides an unbroken single-piece and unitary construction as opposed to conventional door constructions that require a removable bolster to permit access for driving fasteners to secure the door components to a door frame. This permits considerable flexibility in locating the fastener openings 66 in door frame 16.

The modular vehicle door construction afforded by the trim panel 12 and carrier plate 14 facilitates quick and easy assembly of motor vehicle door 10, including the door latch 36, audio speaker 52, and window regulator rails 54, 56, and is well suited for manufacturing assembly lines. This reduces tooling requirements and the complexity of the door assembly as the motor vehicle moves along the assembly line. The presence of the carrier plate 14 eliminates the need for an access opening in the trim panel 12 and a removable door bolster covering the access opening. The trim panel 12 may be provided with an integral and non-removable bolster 46, which eliminates the need for a bolster seal and serves to increase the robustness of the door construction. In addition, the trim panel 12 is provided with the integral speaker grill 48 that covers the audio speaker 40 after assembly. This eliminates the need to supply and attach a separate grill 48 to the trim panel 12, which reduces labor cost. The bolster 46 and speaker grill 48 are molded with the trim panel 12, which reduces manufacturing cost as separate grill covers and bolsters are not required. In an alternative embodiment of the invention, a back-loaded bolster 46 that cannot be removed from the passenger compartment may be provided to satisfy trim panel styling or trim panel cover stock requirements.

The carrier plate 14 is preferably non-structural in that the load presented by the door latch 36, audio speaker 52, and window regulator rails 54, 56 is supported primarily by the door frame 16 after assembly. For example, the weight of a window pane is transferred by the window regulator rails 54, 56 to the door frame 16. As a result, the carrier plate 14 may be formed from a lightweight and/or inexpensive non-load bearing material, such as polypropylene. The carrier plate 14 operates as a water, air and/or sound barrier in the assembled door, which protects the outboard side 20 of the trim panel 12. A water seal (not shown) may be provided about the periphery of the carrier plate 14 and compressed between the carrier plate 14 and door frame 16. The trim panel 12 is removably secured with the door frame 16 by the connectors 28 in the assembled door.

In use and with reference to FIGS. 1-3, a method of assembling an automotive door 10 will be described. Initially, the door latch 36, audio speaker 52, and window regulator rails 54, 56 are positioned on the carrier plate 14, and the trim panel 12 is releasably mounted to the carrier plate 14. The trim panel 12 and carrier plate 14 may be pre-assembled at a remote location as a substantially integral module ready for attachment at any point during the vehicle's final assembly. As a result of the pre-assembly, the door latch 36, audio speaker 52, and window regulator rails 54, 56 may be tested before installation and the door module consisting of the assembled trim panel 12 and carrier plate 14 may be delivered to the assembly line in a state appropriate for immediate installation. Accordingly, the awkward, inconvenient attachment of the door latch 36, audio speaker 52, and window regulator rails 54, 56 through small access openings is substantially eliminated. The vehicle manufacturer benefits from lower inventory requirements and part counts and an improvement in overall product quality.

The carrier plate 14 is positioned relative to the door frame 16 so that the door latch 36 is inserted through cutout 69 and positioned in opening 62, the connectors 28 are registered with the fastener openings 30 in the door frame 16, and the fastener openings 64 in the door latch 36, audio speaker 52, and window regulator rails 54, 56 are registered with corresponding fastener openings 66 in the door frame 16. The locator pins 80, 82 on the door frame 16 are engaged with the locator openings 84, 86 in the carrier plate 14 to assist in positioning and registration. The trim panel 12 is removed from the carrier plate 14 so that an assembly line worker can access the inboard side 22 of the carrier plate 14. The door latch 36, audio speaker 52, and window regulator rails 54, 56 are secured to the door frame 16 by driving fasteners 58 through the pairs of registered fastener openings 64, 66 so that, following assembly, the door latch 36, audio speaker 52, and window regulator rails 54, 56 are secured to both the door frame 16 and the carrier plate 14. Preferably, the door frame 16 carries the majority (i.e., greater than or equal to 50 percent) of the weight of door components, such as the door latch 36, audio speaker 52, and window regulator rails 54, 56, rather than the carrier plate 14. The terminal connector 32 of the wiring harness is re-connected with switchbox 40 to establish electrical connections with the controls 42 on the trim panel 12, the cable 34 connecting the door latch 36 with the inner release handle 38 is connected, and the trim panel 12 is reattached to the door frame 16. The trim panel 12 is completely removable from the door frame 16, in a manner similar to a non-modular door, so that a service technician may readily access the door latch 36,audio speaker 52, and window regulator rails 54, 56.

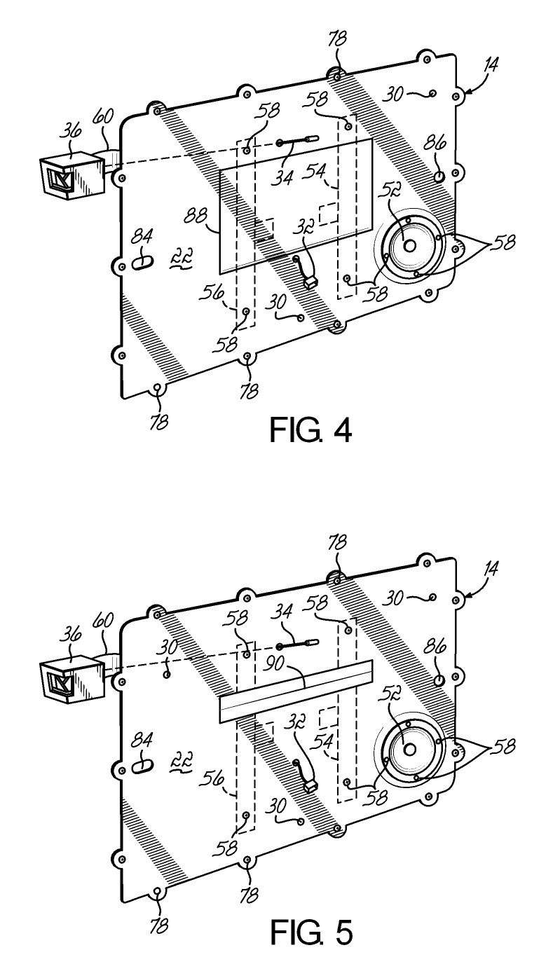

With reference to FIGS. 4 and 5 in which like reference numerals refer to like features in FIGS. 1-3 and in accordance with alternative embodiments of the invention, the carrier plate 14 may be provided with sealable openings to afford access to the space between the carrier plate 14 and the door frame 16. In particular and with reference to FIG. 4, the carrier plate 14 may be provided with a sealable opening in the form of a fold down panel 88 that has an opened position affording access to the outboard side 24 of carrier plate 14 to, for example, install fasteners 58 for the window regulator rails 54, 56 or to position the latch 36 manually and a closed position that is substantially sealed to air, dust and water. Alternatively and with reference to FIG. 5, the sealable opening may consist of a sealable slit 90 extending through the thickness of the carrier plate 14.

While the present invention has been illustrated by the description of one or more embodiments thereof, and while the embodiments have been described in considerable detail, they are not intended to restrict or in any way limit the scope of the appended claims to such detail. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants” general inventive concept.

What is claimed is:

1. A vehicle door assembly for a motor vehicle, comprising:
a door frame;
a door trim panel secured removably to said door frame;
a carrier plate positioned between said door frame and said door trim panel; and
a door component fastened to said door frame and to said carrier plate.

2. The vehicle door assembly of claim 1 wherein said door component is selected from the group consisting of an audio speaker, a door latch, and a window regulator rail.

3. The vehicle door assembly of claim 1 wherein said door frame supports more than 50 percent of the weight of said door component.

4. The vehicle door assembly of claim 3 wherein said carrier plate is formed from a non-structural material that supports less than 50 percent of the weight of said door component.

5. The vehicle door assembly of claim 4 wherein said non-structural material is polypropylene.

6. The vehicle door assembly of claim 1 wherein said carrier plate includes a sealable opening positioned for accessing the door component when said door trim panel is removed from said carrier plate.

7. The vehicle door assembly of claim 1 wherein said trim panel is unitary, and further comprising:
a first plurality of fastener openings in said door frame;
a second plurality of fastener openings in said door component registered with said first plurality of fastener openings; and
a plurality of fasteners installed in said registered first plurality and second plurality of fastener openings to secure said door component to said door frame, said first plurality and second plurality of fastener openings being located arbitrarily inside an outer perimeter of said door frame.

8. A vehicle door assembly for mounting to a door frame of a motor vehicle, comprising:
a carrier plate;
a door component fastened to said carrier plate; and
a door trim panel secured removably to said carrier plate.

9. The vehicle door assembly of claim 8 wherein said door component is selected from the group consisting of an audio speaker, a door latch, and a window regulator rail.

10. The vehicle door assembly of claim 8 wherein said carrier plate is formed from a non-structural material.

11. The vehicle door assembly of claim 10 wherein said non-structural material is polypropylene.

12. A method of assembling a vehicle door of a motor vehicle, comprising:
mounting a carrier plate to a door frame of the vehicle;
removing a trim panel from the carrier plate to reveal a door component secured to the carrier plate;
fastening the door component to the door frame; and
re-securing the trim panel to the carrier plate after the door component is fastened to the door frame.

13. The method of claim 12 wherein fastening the door component to the door frame comprises:
supporting more than 50 percent of a weight of the door component from the door frame after the door component is fastened to the door frame.

14. The method of claim 12 wherein the carrier plate is mounted to the door frame on a vehicle assembly line, and further comprising:
delivering the carrier plate, the door trim panel, and the component to the assembly line as a unit with the door trim panel removably carried by the carrier plate.
